(19) United States
(12) Patent Application Publication
(10) Pub. No.: US 2019/0102737 A1
(43) Pub. Date: Apr. 4, 2019

(54) METHODS AND SYSTEMS FOR RECEIVING FEEDBACK

(71) Applicant: INTERNATIONAL BUSINESS MACHINES CORPORATION, Armonk, NY (US)

(72) Inventors: Arpita G. GUDIHAL, Pune (IN); Shailendra MOYAL, Pune (IN)

(73) Assignee: INTERNATIONAL BUSINESS MACHINES CORPORATION, Armonk, NY (US)

(21) Appl. No.: 15/723,650

(22) Filed: Oct. 3, 2017

(51) Int. Cl. G06Q 10/10; G06F 17/30

(52) U.S. Cl. CPC G06Q 10/10; G06F 17/30528

(57) ABSTRACT

Embodiments for receiving feedback from individuals by one or more processors are described. A score associated with a mental state of at least one individual regarding responding to an inquiry is determined. If the determined score is below a predetermined threshold, a signal indicative of a recommended communication with the at least one individual is generated.

### BACKGROUND OF THE INVENTION

### Field of the Invention

The present invention relates in general to computing systems, and more particularly, to various embodiments for receiving feedback.

### Description of the Related Art

Surveys, questionnaires, and the like are often used to receive feedback or input from individuals in various environments. As one example, companies (or employers) sometimes provide employees with surveys in order to gain an understanding of, for example, the employees' satisfaction, attitude, motivation, etc. regarding their current employment situation and/or ideas for improvement.

If the surveys are sent to the employees in a regular and/or frequent manner, it may be possible for the employer to identify potential issues and/or attempt to remedy the situations relatively quickly. When this is the case, and the employees are made aware of the changes made, they may be encouraged to enthusiastically participate in future surveys, as they may feel their input is being utilized. However, depending on various factors, such as the mental and/or emotional state of the participants, the information received utilizing such surveys may not be entirely accurate and/or less helpful than is ideal.

### SUMMARY OF THE INVENTION

Various embodiments for receiving feedback from individuals by one or more processors are described. A score associated with a mental state of at least one individual regarding responding to an inquiry is determined. If the determined score is below a predetermined threshold, a signal indicative of a recommended communication with the at least one individual is generated.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a block diagram depicting an exemplary computing node according to an embodiment of the present invention;

FIG. 2 is an additional block diagram depicting an exemplary cloud computing environment according to an embodiment of the present invention;

FIG. 3 is an additional block diagram depicting abstraction model layers according to an embodiment of the present invention;

FIG. 4 is a plan view/block diagram of a system for receiving feedback according to an embodiment of the present invention;

FIG. 5 is a flowchart/block diagram depicting various steps and aspects of functionality according to an embodiment of the present invention; and

FIG. 6 is a flowchart diagram depicting an exemplary method for receiving feedback in which various aspects of the present invention may be implemented.

### DETAILED DESCRIPTION OF THE DRAWINGS

As discussed above, surveys, questionnaires, and the like are often used to receive feedback or input from individuals in various environments. As one example, companies (or employers) sometimes provide employees with surveys in order to gain an understanding of, for example, the employees' satisfaction, attitude, motivation, etc. regarding, along with ideas for improving, their current employment situation. Doing so may help the employer in identifying potential issues and/or remedying the situations relatively quickly. When this is the case, and the employees are made aware of the changes made, they may be encouraged to enthusiastically participate in future surveys, as they may feel their input is being utilized. However, depending on various factors, the information received during such surveys may not be entirely accurate and/or less helpful than is ideal.

Consider an example in which a particular employee receives (e.g., via an electronic message, such as an email) a request (or requirement) to complete a survey when he/she is relatively busy. In such an instance, completing the survey may be viewed as more of just another task that has to be completed, as opposed to an opportunity to improve their work environment. As such, the employee may rush through the survey simply to complete it as quickly as possible and not fully and/or honestly answer the questions. Similarly, if the employee receives the survey at a “bad time” (e.g., the employee is in a bad mood or is particularly frustrated with something related to his/her work), the feedback received may not accurately reflect the employee's thoughts/feelings, in which case, any changes made in response to the survey may not be particularly beneficial. Further, if the employee is repeatedly sent reminders to complete the survey, his/her frustration with the situation may be increased.

In view of the foregoing, a need exists for methods and systems for receiving feedback in which the mental and/or emotional state of the participants (e.g., employees, customers, etc.) is monitored, and in the event that their mental/emotional state is determined to be below a predetermined threshold at a particular time (e.g., before they are presented with a survey or questionnaire), provide an indication of such, which may be utilized (e.g., by an administrator of the survey) to provide some form of encouragement to the participants before they complete the survey. Additionally, a need exists for methods and systems that allow the participants to be made aware that the feedback received during previous surveys has been considered and, when appropriate, utilized to make changes.

To address these needs, embodiments described herein provide methods and systems for receiving feedback from individuals by one or more processors. A score associated with a mental state (i.e., a mental and/or emotional state score) of at least one individual or participant (e.g., an employee, a customer, etc.) regarding responding to an inquiry is determined. If the determined score is below a predetermined threshold, a signal indicative of a recommended communication (or intervention) with the at least one individual is generated.

The inquiry (e.g., a survey, questionnaire, etc.) may (then) be caused to be provided to the participant(s) and/or the participant(s) may complete the inquiry. If the determined mental (and/or emotional) state score is below the predetermined threshold, the causing of the inquiry to be provided to the participant may be performed after the generating of the signal indicative of the recommended communication. If the determined mental state score is above the predetermined threshold, the causing of the inquiry to be provided to the participant may be performed without the generating of the signal indicative of the recommended communication.

The mental state score of the participant may be determined using, for example, suitable analytics based on at least one of facial information associated with the at least one individual, a physiological condition (e.g., heart rate, blood pressure, etc.) associated with the at least one individual, and electronic messages associated with the at least one individual. The recommended communication may include a communication between at least one second individual (e.g., a manager) and the participant and be associated with the inquiry (e.g., the recommended communication may be a communication and/or meeting with the participant intended to encourage the participant to completely and honestly complete the inquiry). Feedback may then be received from the participant via, for example, the inquiry.

In some embodiments, the feedback received from the participant(s) is utilized to implement changes in the appropriate environment (e.g., a workplace, with respect to customer service, etc.). The changes may be made apparent to the participant(s) (e.g., via advertising, electronic messages, signs, descriptions thereof in future inquiries, etc.) to inform the participant(s) that the feedback received from the inquiry (or previous inquiries) has been considered and/or utilized to make changes, which may result in further encouraging the participant(s) to complete future inquiries.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

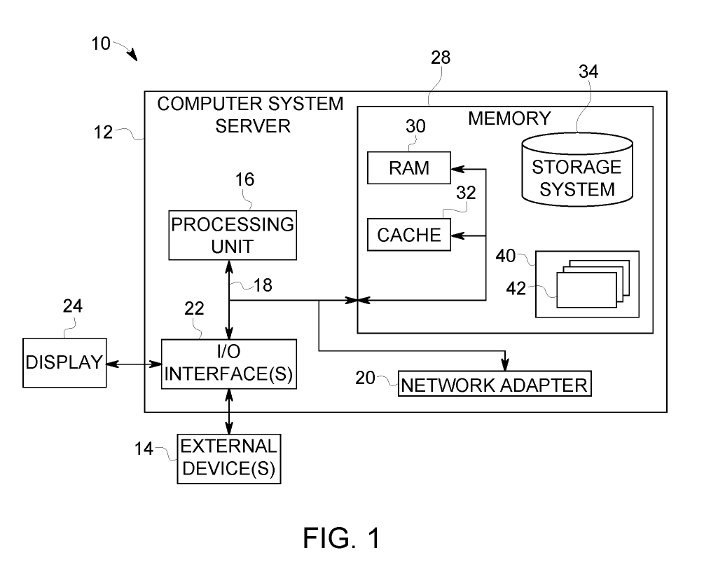

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 (and/or one or more processors described herein) is capable of being implemented and/or performing (or causing or enabling) any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, system memory 28 may include at least one program product having a set (e.g., at least one) of program modules that are configured to carry out the functions of embodiments of the invention.

Program/utility 40, having a set (at least one) of program modules 42, may be stored in system memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples include, but are not limited to: microcode, device drivers, redundant processing units, external disk drive arrays, RAID systems, tape drives, and data archival storage systems, etc.

In the context of the present invention, and as one of skill in the art will appreciate, various components depicted in FIG. 1 may be located in computing devices, such as personal computer systems, hand-held or laptop devices, and network PCs or servers, and/or various other devices, such as wearable technology devices (or wearables or wearable devices) and sensors (e.g., cameras). For example, some of the processing and data storage capabilities associated with mechanisms of the illustrated embodiments may take place locally via local processing components, while the same components are connected via a network to remotely located, distributed computing data processing and storage components to accomplish various purposes of the present invention. Again, as will be appreciated by one of ordinary skill in the art, the present illustration is intended to convey only a subset of what may be an entire connected network of distributed computing components that accomplish various inventive aspects collectively.

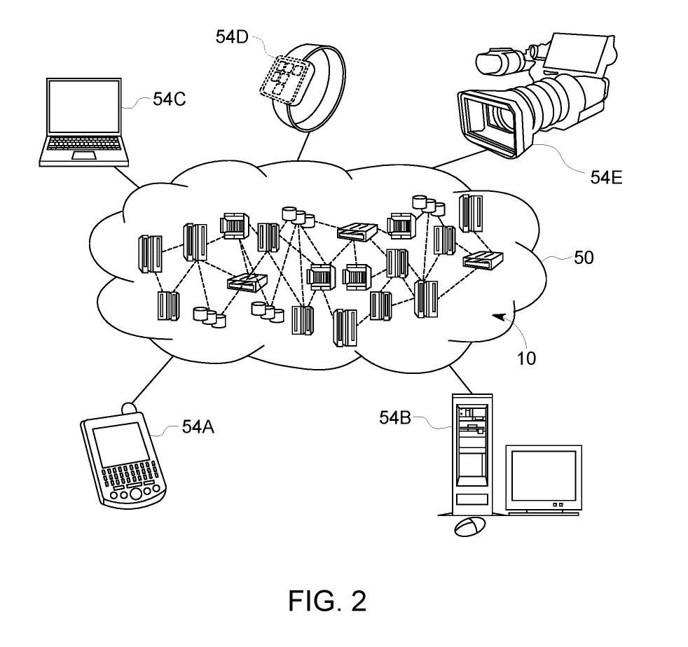

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, wearable device 54D, and/or sensor (e.g., a camera) 54E may communicate.

Still referring to FIG. 2, nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-E shown in FIG. 2 are intended to be illustrative only and that computing nodes 10 and cloud computing environment 50 can communicate with any type of computerized device over any type of network and/or network addressable connection (e.g., using a web browser).

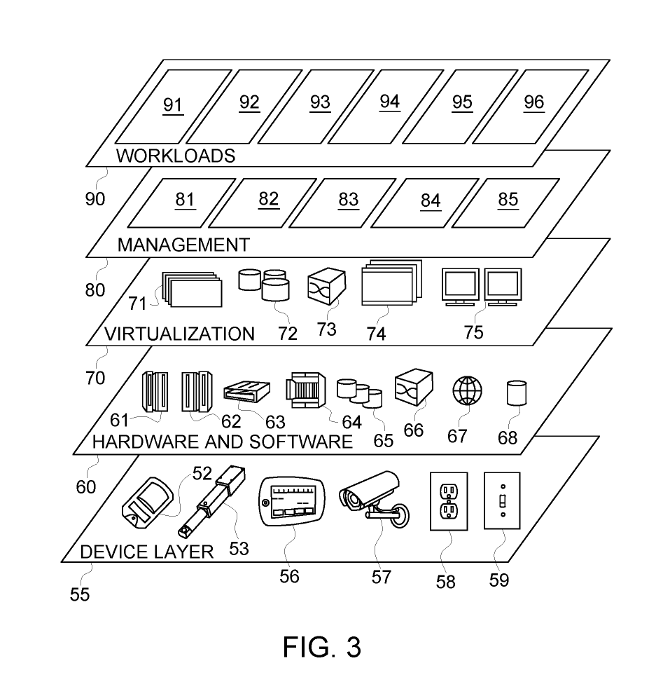

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Device layer 55 includes physical and/or virtual devices, embedded with and/or standalone electronics, sensors, actuators, and other objects to perform various tasks in a cloud computing environment 50. Each of the devices in the device layer 55 incorporates networking capability to other functional abstraction layers such that information obtained from the devices may be provided thereto, and/or information from the other abstraction layers may be provided to the devices. In one embodiment, the various devices inclusive of the device layer 55 may incorporate a network of entities collectively known as the “internet of things” (IoT). Such a network of entities allows for intercommunication, collection, and dissemination of data to accomplish a great variety of purposes, as one of ordinary skill in the art will appreciate.

Device layer 55 as shown includes sensor 52, actuator 53, “learning” thermostat 56 with integrated processing, sensor, and networking electronics, camera 57, controllable household outlet/receptacle 58, and controllable electrical switch 59 as shown. Other possible devices may include, but are not limited to wearable technology devices (or wearables or wearable devices), such as wristbands, wristwatches, earpieces, clothing, eyewear, headwear, etc., and various additional sensor devices (e.g., cameras), networking devices, electronics devices (such as a remote control device), additional actuator devices, so called “smart” appliances such as a refrigerator or washer/dryer, and a wide variety of other possible interconnected objects.

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provides cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and, in the context of the illustrated embodiments of the present invention, various workloads and functions 96 for receiving feedback as described herein. One of ordinary skill in the art will appreciate that the workloads and functions 96 for receiving feedback may also work in conjunction with other portions of the various abstractions layers, such as those in hardware and software 60, virtualization 70, management 80, and other workloads 90 (such as data analytics processing 94, for example) to accomplish the various purposes of the illustrated embodiments of the present invention.

As previously mentioned, the methods and systems of the illustrated embodiments provide novel approaches for receiving feedback by one or more processors. A mental (and/or emotional) state score associated with at least one individual or participant (e.g., an employee, a customer, etc.), or more particularly, a score associated with a mental state of the at least one individual regarding responding to an inquiry, is determined. If the determined mental state score is below a predetermined threshold, a signal indicative of a recommended communication with the participant(s) is generated. An inquiry (e.g., a survey, questionnaire, etc.) may (then) be caused to be provided to the participant(s). The inquiry may be provided to the participant(s) in any suitable form (e.g., electronic form/questionnaire, physical “pen and paper,” etc.).

If the determined mental (and/or emotional) state score is below the predetermined threshold, the causing of the inquiry to be provided to the participant may be performed after the generating of the signal indicative of the recommended communication. If the determined mental state score is above the predetermined threshold, the causing of the inquiry to be provided to the participant may be performed without the generating of the signal indicative of the recommended communication.

The mental state score of the participant may be determined based on at least one of facial information associated with the at least one individual, a physiological condition associated with the at least one individual, and electronic messages associated with the at least one individual. The recommended communication may include a communication between at least one second individual (e.g., a manager) and the participant and be associated with the inquiry (e.g., the recommended communication may be a communication and/or meeting with the participant intended to encourage the participant to completely and honestly complete the inquiry). Feedback may then be received from the participant via, for example, the inquiry.

In some embodiments, the feedback received from the participant(s) is utilized to implement changes in the appropriate environment (e.g., a workplace, with respect to customer service, etc.). The changes may be made apparent to the participant(s) (e.g., via advertising, electronic messages, signs, descriptions thereof in future inquiries, etc.) to inform the participant(s) that the feedback received from the inquiry (i.e., previous inquiries) has been considered and/or utilized to make changes, which may result in further encouraging the participant(s) to complete future inquiries.

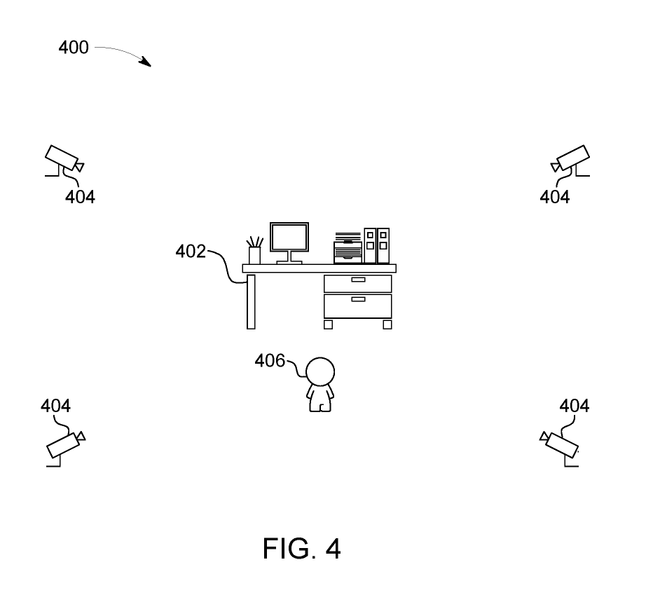

Referring now to FIG. 4, a system (and/or location) 400 in which embodiments described herein may be implemented is illustrated. In the particular embodiment shown in FIG. 4, a workspace (or desk) 402 and sensors 404 are shown. In this particular example, the location 400 may correspond to, for example, a workplace environment. However, it should be understood that the embodiments described herein may be applied to other environments/scenarios, such as schools, retail locations (e.g., stores), public places (e.g., parks), or any environment/scenario in which it may be desirable to receive feedback from individuals who take part in any activities that occur at the location. Still referring to FIG. 4, a single individual (e.g., an employee) 406 is also shown (though it should be understood that multiple individuals may be present and/or participate in some embodiments).

The sensors 404 may be any sensors, combination of sensors, and/or other devices configured to (and/or which may be utilized to) monitor the activity of individuals at location 400. In some embodiments, the sensors 404 include electromagnetic sensors, such as cameras, perhaps combined with an infrared light source, and/or microphones. Although multiple sensors 404 are shown in FIG. 4, it should be understood that in some embodiments, only a single sensor 404 may be utilized.

In some embodiments, the sensors 404 may be utilized to perform facial recognition and/or “emotion recognition.” That is, the sensors (and/or any computing system utilized within the system) may be able to identify individuals to some extent (e.g., determine the particular identification or name of the individual, determine whether or not the individual is part of a predetermined group, such as an employee of a company, etc. based on facial structure) and/or recognize the facial expressions, eye movements, etc. of the individual to determine their emotional state or state of mind (e.g., whether or not the individual is in a “good mood” or “bad mood”). In embodiments in which the sensors 404 include microphones, recording/monitoring conversations (e.g., keywords therein) in which the individual takes part may (also) be utilized to determine the emotional state of the individual(s) 406.

Although not shown in FIG. 4, in some embodiments, the sensors 404 may (also) include one or more sensors within a wearable device on (i.e., worn by) the individual 406, such as a wristband or a wristwatch. In particular, the wearable device (e.g., shown in FIG. 2) may include one or more physiological sensors that may be configured to monitor the physiological functioning of the body of the individual 406, such as, but not limited to, sensors for monitoring heart (or pulse) rate, blood pressure, breathing rate, and/or any other appropriate physiological characteristics that may be indicative of (and/or useful in determining) the mental and/or emotional state of individuals.

In some embodiments, a mental (and/or emotional) state (or mental/emotional state score) of the individual(s) 406 is determined based, at least in part, on information received by the sensors (e.g., emotion recognition via cameras and/or physiological data via the wearable device). In some embodiments, the mental/emotional state of the individual(s) 406 may (also) be based on, for example, electronic messages associated with the individuals. For example, in some embodiments, various forms of electronic communications (e.g., emails, text messages, social media posts, etc.) may be (automatically) scanned (e.g., for keywords, phrases, emoticons, etc.) that may (also) be utilized to determine the mental/emotional state of the individual(s) 406. These factors, or combination of factors, may be utilized to generate, for example, a numerical score (e.g., which may be on any appropriate scale) that is associated with the mental and/or emotional state of the individual 406, which may be utilized as described below.

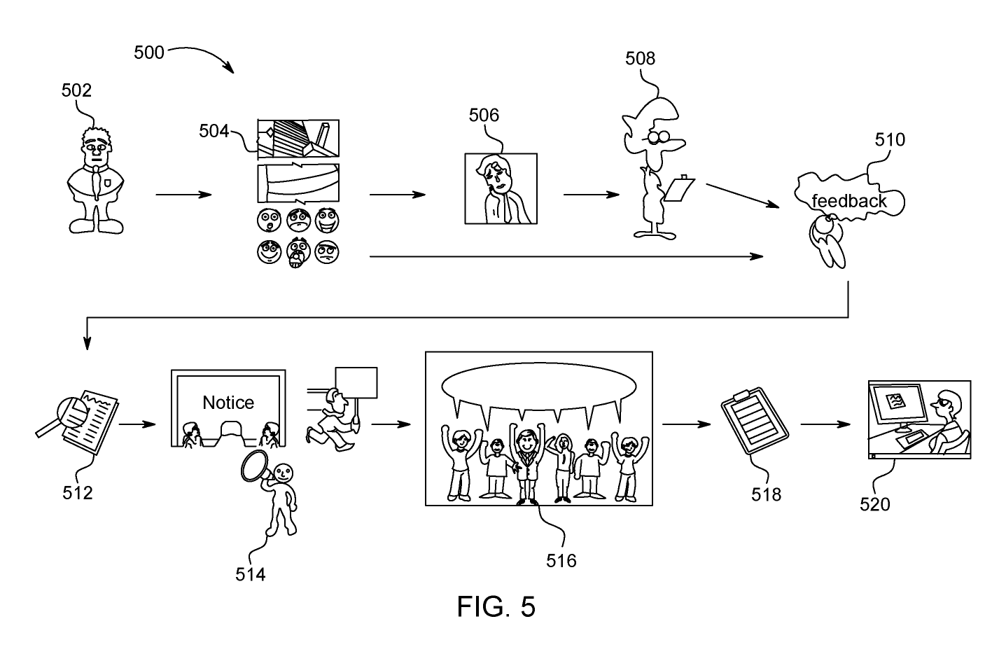

FIG. 5 is a block diagram/flowchart illustrating various aspects of functionality according to at least some of the embodiments described herein. It should be understood that the functionality indicated in FIG. 5 by blocks (or steps) 502-520 is only intended to provide an example of the embodiments described herein, as in other embodiments the order in which the blocks 502-520 are implemented may change and/or a different number of blocks (e.g., more or less) may be utilized. For example, in some embodiments, before block (or step) 502 occurs, a survey or questionnaire intended to be completed by an individual, or groups of individuals, such as employees, may be generated or published by an appropriate entity (e.g., management and/or a human resources department of a company). In some embodiments, the survey may (also) be provided to the employees (e.g., via email) before block (or step) 502 occurs.

At block 502, the presence of an employee(s) (i.e., a participant) is detected. In some embodiments, this may refer to the employee being physically present at an office or worksite. However, it may also refer to the employee being in any location and/or performing any activities (e.g., sending emails, social media activity, etc.) that may be utilized to determine the mental/emotional state of the employee.

At block 504, data to be used to determine the mental/emotional state of the employee is received (or retrieved). In some embodiments, the data includes data retrieved from sensors (e.g., cameras and/or microphones), physiological data retrieved by a wearable device (e.g., regarding heart rate, blood pressure, etc.), and/or data from electronic communications (e.g., emails, text messages, social media posts, etc.). These factors, or combination of factors, may be utilized to generate, for example, a score (e.g., numeric score) that may be associated with the mental and/or emotional state of the employee.

At block 506, in some embodiments, if the mental/emotional state score of the employee is below a predetermined threshold, before the employee(s) completes (or receives) the survey, a signal is generated (e.g., automatically) that indicates a recommendation that some form of communication with the individual be performed. As an example, the sensors described above may be utilized to detect facial expressions that indicate the employee is unhappy and/or keywords in electronic communications sent by the employee may indicate that he/she is frustrated with some aspect of his/her work environment, resulting in a mental/emotional state score below the predetermined threshold. In response, a manager or some other appropriate personnel, may receive a message (e.g., via email, text message, phone call, etc.) indicating the mental/emotional state of the employee(s) and recommend that he/she have a meeting or conversation with the employee(s) to encourage them to complete the survey in a comprehensive and honest manner and to assure them that their concerns will be taken into consideration. Alternatively, the employee may (also) automatically receive some form encouragement via, for example, emails, videos, audio presentations, etc.

As such, at block 508, such a communication (e.g., meeting or conversation) is performed, and at block 510 the employee(s) completes the survey, having been previously encouraged to do so.

However, as shown in FIG. 5, if the mental state score is above the predetermined threshold, as determined using the data received at block 504, the employee may be presented with and/or complete the survey, at block 510, without any sort of communication (or intervention) intended to provide encouragement. In other words, if the employee is determined to be in an appropriate mental/emotional state to complete the survey, the survey may be presented to and/or completed by the employee without any form of extra encouragement.

At block 512, the information (or feedback) is retrieved from the completed survey(s), and the organization (i.e., the company/employer) determines what changes, if any, should be made (e.g., with respect to the workplace environment, job duties, etc.).

At block 514, indications of the planned changes and/or already implemented changes are created. That is, in some embodiments, the employee(s) may be made aware of the planned changes/changes made in response to the feedback received via the survey(s). Such indications may be made in any suitable manner including, for example, electronic communications (e.g., email, text messages, social media, telephone, etc.), audio announcements (e.g., performed via a public address system at the workplace), physical/visual messages (e.g., signs, placards, notifications sent via mail, etc.), and the like. As such, it should be understood that some of the indications (as well as some of the other blocks/steps described herein) may be performed via automatically generated signals (e.g., emails, etc.), while some of the indications may require manual intervention (e.g., hanging signs).

At block 516, the employee(s) become aware of the changes via the indications created at block 514. This may result in the employees (or participants) being pleased and cause, for example, the employees to talk about the changes, and how their feedback was utilized to implement the changes, amongst themselves.

In some embodiments, at block 518, the changes made in response to previous surveys (e.g., the survey carried out with respect to block 510) are listed and described in a subsequent survey(s) in order to, for example, remind the participants how their previous input was used to make changes. As a result, the employees are provided with additional encouragement to enthusiastically, comprehensively, and honestly complete the subsequent survey, at block 520, perhaps without the need for additional encouragement. In other words, because the employees are provided with indications of how their previous feedback was utilized to implement changes in the workplace, the likelihood of their emotional/mental state being determined to be below the predetermined threshold described above may be reduced.

It should be noted that at least some of the aspects of functionality and/or signals representative/indicative thereof described above may be performed and/or generated automatically. For example, if the system is made aware of a currently outstanding or upcoming survey, the mental/emotional state of the participants may be automatically monitored as described above. As another example, surveys may be automatically generated in such a way to include a description of changes that were implemented based on feedback received from previous surveys.

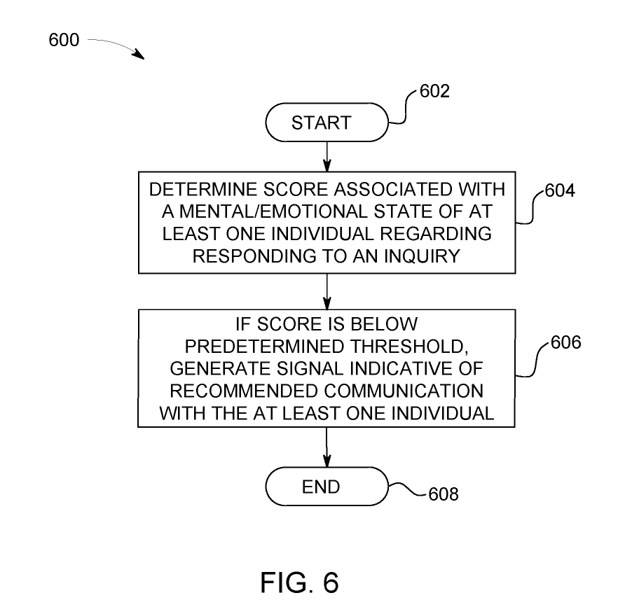

Turning to FIG. 6, a flowchart diagram of an exemplary method 600 for receiving feedback, in accordance with various aspects of the present invention, is illustrated. Method 600 begins (step 602) with, for example, a decision to provide at least one individual (e.g., a participant, employee, etc.) with a survey (or questionnaire) in order to receive feedback and/or with such a survey being generated or created.

A score associated with a mental state (i.e., a mental/emotional state score) of at least one individual regarding responding to an inquiry is determined (step 604). As described above, the mental/emotional state score may be determined based on, for example, information received by sensors (e.g., emotion recognition via cameras and/or physiological data via a wearable device) and/or electronic messages/communication associated with the individuals (e.g., scanning emails, text messages, social media posts, etc. for keywords, phrases, emoticons, etc.).

If the determined mental/emotional state score is below a predetermined threshold, a signal is generated (step 606), which is indicative of a recommendation that some form of communication, or intervention, with the at least one individual be carried out in order to, for example, provide encouragement regarding completing the survey. For example, in a workplace environment, a manager or some other appropriate personnel, may receive a message (e.g., via email, text message, phone call, etc.) indicating the mental/emotional state of the individual(s) (e.g., an employee) and/or recommending that he/she have a meeting or conversation with the individual(s) to encourage them to complete the survey.

Method 600 ends (step 608) with, for example, the individual(s) completing the survey in the appropriate manner (e.g., via an electronic device, etc.). As described above, after the feedback is received via the survey(s) and appropriate changes have been implemented by the appropriate personnel, the individual(s) who participated in the survey may be made aware of how the feedback was utilized to make the changes in order to, for example, provide encouragement to complete future surveys.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowcharts and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowcharts and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowcharts and/or block diagram block or blocks.

The flowcharts and block diagrams in the figures illustrate the architecture, functionality, and operation of possible implementations of systems, methods, and computer program products according to various embodiments of the present invention. In this regard, each block in the flowcharts or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts or carry out combinations of special purpose hardware and computer instructions.

1. A method, by one or more processors, for receiving feedback from individuals, comprising:
determining a score associated with a mental state of at least one individual regarding responding to an inquiry; and
if the determined score is below a predetermined threshold, generating a signal indicative of a recommended communication with the at least one individual.

2. The method of claim 1, further comprising causing the inquiry to be provided to the at least one individual.

3. The method of claim 2, wherein if the determined score is below the predetermined threshold, the causing of the inquiry to be provided to the at least one individual is performed after the generating of the signal indicative of the recommended communication.

4. The method of claim 2, wherein if the determined score is above the predetermined threshold, the causing of the inquiry to be provided to the at least one individual is performed without the generating of the signal indicative of the recommended communication.

5. The method of claim 1, wherein the determining of the score is based on at least one of facial information associated with the at least one individual, a physiological condition associated with the at least one individual, and electronic messages associated with the at least one individual.

6. The method of claim 1, wherein the recommended communication includes a communication between at least one second individual and the at least one individual, wherein the recommended communication is associated with the inquiry.

7. The method of claim 2, further comprising receiving feedback from the at least one individual, wherein the feedback is associated with the inquiry.

8. A system for receiving feedback from individuals, comprising:
at least one processor that
determines a score associated with a mental state of at least one individual regarding responding to an inquiry; and
if the determined score is below a predetermined threshold, generates a signal indicative of a recommended communication with the at least one individual.

9. The system of claim 8, wherein the at least one processor further causes the inquiry to be provided to the at least one individual.

10. The system of claim 9, wherein if the determined score is below the predetermined threshold, the causing of the inquiry to be provided to the at least one individual is performed after the generating of the signal indicative of the recommended communication.

11. The system of claim 9, wherein if the determined score is above the predetermined threshold, the causing of the inquiry to be provided to the at least one individual is performed without the generating of the signal indicative of the recommended communication.

12. The system of claim 8, wherein the determining of the score is based on at least one of facial information associated with the at least one individual, a physiological condition associated with the at least one individual, and electronic messages associated with the at least one individual.

13. The system of claim 8, wherein the recommended communication includes a communication between at least one second individual and the at least one individual, wherein the recommended communication is associated with the inquiry.

14. The system of claim 9, wherein the at least one processor further receives feedback from the at least one individual, wherein the feedback is associated with the inquiry.

15. A computer program product for receiving feedback from individuals by one or more processors, the computer program product comprising a non-transitory computer-readable storage medium having computer-readable program code portions stored therein, the computer-readable program code portions comprising:
an executable portion that determines a score associated with a mental state of at least one individual regarding responding to an inquiry; and
an executable portion that, if the determined score is below a predetermined threshold, generates a signal indicative of a recommended communication with the at least one individual.

16. The computer program product of claim 15, wherein the computer-readable program code portions further include an executable portion that causes the inquiry to be provided to the at least one individual.

17. The computer program product of claim 16, wherein if the determined score is below the predetermined threshold, the causing of the inquiry to be provided to the at least one individual is performed after the generating of the signal indicative of the recommended communication.

18. The computer program product of claim 16, wherein if the determined score is above the predetermined threshold, the causing of the inquiry to be provided to the at least one individual is performed without the generating of the signal indicative of the recommended communication.

19. The computer program product of claim 15, wherein the determining of the score is based on at least one of facial information associated with the at least one individual, a physiological condition associated with the at least one individual, and electronic messages associated with the at least one individual.

20. The computer program product of claim 15, wherein the recommended communication includes a communication between at least one second individual and the at least one individual, wherein the recommended communication is associated with the inquiry.

21. The computer program product of claim 16, wherein the computer-readable program code portions further include an executable portion that receives feedback from the at least one individual, wherein the feedback is associated with the inquiry.
